(19) United States
(12) Patent Application Publication
(10) Pub. No.: US 2005/0117548 A1
(43) Pub. Date: Jun. 2, 2005

(54) Nonblocking ovsf codes for 3g wireless and beyond systems

(76) Inventor: Hasan Cam, Tempe, AZ (US)

Correspondence Address: CHRISTIE, PARKER & HALE, LLP, PO BOX 7068, PASADENA, CA, 91109-7068, US

(21) Appl. No.: 10/505,604

(22) PCT Filed: Feb. 22, 2003
(86) PCT No.: PCT/US03/05541

Related U.S. Application Data
(60) Provisional application No. 60/358,893, filed on Feb. 22, 2002.
(60) Provisional application No. 60/362,532, filed on Mar. 6, 2002.

(51) Int. Cl. H04B 7/216

(52) U.S. Cl. 370/335; 370/342

(57) ABSTRACT

Methods and apparatus are described for transmitting data using a wideband code division multiple access (WCDMA) transmission scheme that utilizes OVSF codes that are assigned in ways that do not result in underutilization of the network due to code blocking. One embodiment of the invention includes a WCDMA transmitter configured to spread data using an orthogonal variable spreading factor (OVSF) code and to periodically transmit the spread data for a predetermined time until all of the data has been transmitted. In some cases, the amount of time in each period that is assigned for transmission of the spread data is determined based on the quality of service requirements of the data.

### FIELD OF THE INVENTION

The present invention relates generally to wireless communication systems and more specifically to the use of non-blocking orthogonal variable spreading factor (OVSF) codes in wideband code division multiple access (WCDMA) communication systems.

### BACKGROUND OF THE INVENTION

Wireless communication systems can use WCDMA to provide high data rate and variable bit rate services with differing quality of service (QoS) requirements. WCDMA is a form of spread spectrum communication in which multiple users share the same carrier. Spread spectrum communication refers to a transmission technique in which the data of interest occupies a bandwidth in excess of the minimum bandwidth necessary to send the data. The spectrum spreading is accomplished before transmission using a code that is independent of the data sequence. The same code is used in the receiver to despread the received signal so that the original data may be recovered. Code division multiple access (CDMA) systems are characterized in that they allow multiple users to transmit on the same bandwidth by using spreading codes that are orthogonal.

WCDMA is a variety of CDMA transmission that allows users transmitting at different bit rates to share the same frequency spectrum. Typically, differing bandwidths of frequency spectrum are required to transmit data streams having different quality of service requirements. WCDMA systems spread a data stream using a spreading code that increases the bandwidth required to transmit the spread data in proportion to the spreading factor of the spreading code. By using codes that have different spreading factors, a WCDMA system can ensure that each of the spread data streams occupies the same bandwidth of frequency spectrum. The codes used to spread data streams by varying amounts are often referred to as OVSF codes and once data has been spread, the bits of spread data that are transmitted are referred to as “chips”.

OVSF codes can be generated recursively in a binary tree structure using Walsh matrices or by applying the following rule recursively:
code C_{n,i} of length n generates the following two orthogonal codes of length 2n:
   C_{2n,i}=[C_{n,i},C_{n,i}]
   C_{2n,i+1}=[C_{n,i}−C_{n,i}]

Where
−C_{n,i} denotes the binary complement of C_{n,i};
n denotes a spreading factor that is a power of 2; and
i denotes an index.

Codes generated using either of the above techniques are not orthogonal to any of their ancestor or descendant codes. Therefore, the assignment of a particular code can prevent the assignment of other codes and ultimately lead to the under utilization of the network. Under utilization can occur, because calls that the network has the capacity to handle are blocked due to the inability of the network to assign the user code that is orthogonal to the codes already being used by other users. The problem of underutilization due to code blocking has led to the development of several code reassignment algorithms. These heuristic algorithms often lead to a chain of code reassignments that result in significant overhead, because many receivers need to be informed of new code reassignments. In some systems, this overhead can also result in a call being blocked due to insufficient network resources being available to accomplish the code reassignments.

### SUMMARY OF THE INVENTION

Embodiments of the present invention can provide high utilization of downlink channels by assigning OVSF codes to real time traffic streams in a manner that does not prevent the future assignment of other OVSF codes. One embodiment that transmits real time data that has specified quality of service requirements includes a WCDMA transmitter configured to spread the data using an OVSF code and to periodically transmit the spread data for a predetermined time until all of the data has been transmitted. This embodiment also requires that the amount of time in each period that is assigned for transmission of the spread data is determined based on the quality of service requirements of the data.

In another embodiment, the system also includes a WCDMA receiver configured to receive data periodically transmitted for a predetermined time using a predetermined OVSF code. The WCDMA transmitter can be configured to transmit messages indicative of the time allocated during each period for transmission of the data and messages indicative of the OVSF code used to transmit the data and the WCDMA receiver can be configured to receive the messages transmitted by the WCDMA transmitter. In addition, the WCDMA receiver can be configured to synchronize to the transmissions of the WCDMA transmitter. In an alternative embodiment, the WCDMA transmitter is connected to a core network and the WCDMA receiver is connected to a user device.

The method of the invention includes determining the quality of service requirements of the service, determining the number of time slots that must be assigned to the service for the quality of service requirements to be met if the data is transmitted using a predetermined spreading factor, assigning time slots to the service, assigning an OVSF code possessing the predetermined spreading factor to the service, spreading the data using the assigned OVSF code and periodically transmitting the spread data during the assigned time slots. The method of the invention can also include transmitting messages indicating the assigned time slots and the assigned OVSF code and transmitting signals that can be used to identify the time at which the spread data is transmitted.

### BRIEF DESCRIPTION OF THE DRAWINGS

FIG. 1 is a schematic diagram of a network in accordance with the present invention;

FIG. 2 is a semi-schematic circuit diagram of a WCDMA base station in accordance with the present invention;

FIG. 3 is a semi-schematic circuit diagram of a mobile WCDMA transceiver in accordance with the present invention;

FIG. 4 is a semi-schematic circuit diagram of a WCDMA transmitter in accordance with the present invention;

FIG. 5 is a semi-schematic circuit diagram of a WCDMA receiver in accordance with the present invention;

FIG. 6 is a flowchart illustrating the process of transmitting data using a WCDMA system in accordance with the present invention;

FIG. 7 is a flowchart illustrating operations that can be involved in the call setup process shown in the flowchart of FIG. 6;

FIG. 8 is a flowchart illustrating operations performed by a transmitter in requesting the establishment of a WCDMA service in accordance with the present invention;

FIG. 9 is a flowchart illustrating operations performed by a receiver in responding to a request to establish a WCDMA service in accordance with the present invention;

FIG. 10 is a flowchart illustrating operations performed by a transmitter when determining the number of time slots to request during call setup;

FIG. 11 is a flowchart illustrating the operations performed by a transmitter to synchronize and transmit data to a receiver in accordance with the present invention;

FIG. 12 is a flowchart illustrating the operations performed by a receiver to synchronize and receive data from a transmitter in accordance with the present invention;

FIG. 13a is a flowchart illustrating the arrival of real time data and the spreading of the data by a transmitter in accordance with the present invention;

FIG. 13b is a flowchart illustrating the operations performed by a transmitter to transmit spread data in accordance with the present invention;

FIG. 14 is a flowchart illustrating operations performed by a receiver in receiving data in accordance with the present invention;

FIG. 15 is a flowchart illustrating the generation of non-blocking OVSF codes for systems possessing a minimum desired spreading factor and maximum desired spreading factor;

FIG. 16 is a binary code tree illustrating non-blocking OVSF codes generated in accordance with the process illustrated in FIG. 15;

FIG. 17 is a flow chart illustrating the generation of non-blocking OVSP codes for systems that do not have a maximum allowable spreading factor; and

FIG. 18 is a binary code tree illustrating the generation of “BOVSF” codes and non-blocking OVSF codes in accordance with the process illustrated in FIG. 17.

### DETAILED DESCRIPTION OF THE INVENTION

Referring now to the drawings, a system 10 for transmitting data on a downlink channel between a base station 12 and users 16 is illustrated. The data on the downlink channel is spread using OVSF codes. In one embodiment, the system ensures that the assigned OVSF codes have the same spreading factor. This system accommodates services having different data rates or qualities of service by dividing transmission time on the downlink channel into time slots and apportioning variable numbers of time slots depending upon user requirements. In other embodiments, non-blocking OVSF codes are used to spread data Non-blocking OVSF codes can be used to accommodate different qualities of service, because different spreading factor codes can be assigned in a way that does not result in the blocking of the assignment of other spreading factor codes.

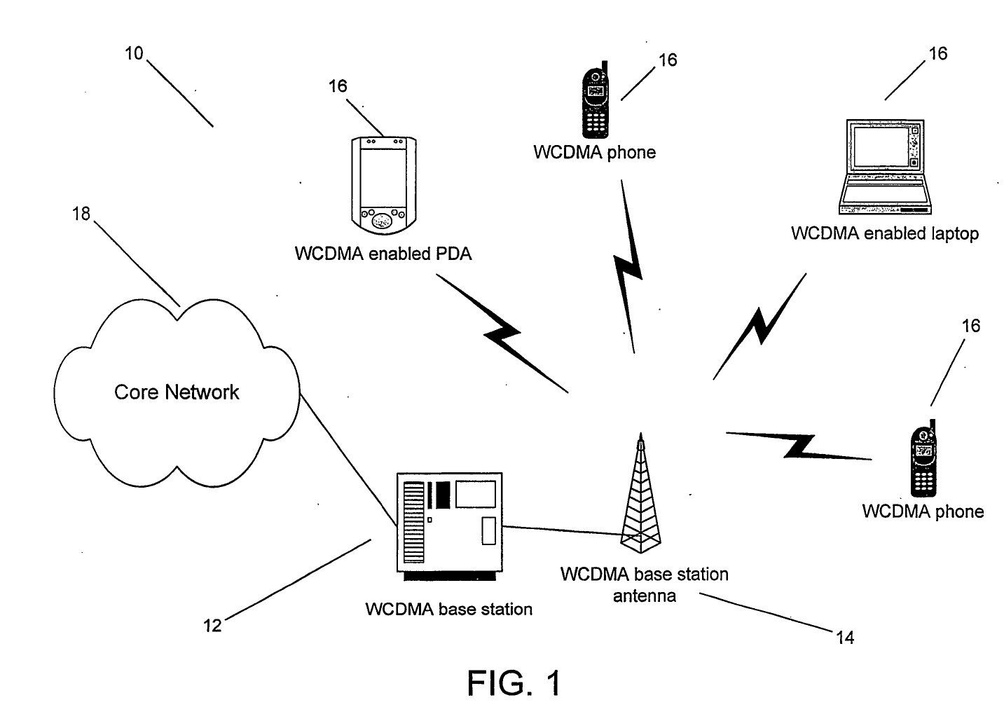

A system in accordance with the present invention is shown in FIG. 1. The system 10 includes a WCDMA base station 12 that uses an antenna 14 to transmit data on a downlink channel to a number of users 16 that have devices equipped with WCDMA transceivers in accordance with the present invention. Examples of devices that can be equipped with WCDMA transceivers are shown in FIG. 1 and these include personal digital assistants or “PDAs”, mobile telephones and laptop computers. The WCDMA base station can also receive data on uplink channels from the user devices. The WCDMA base station provides an interface between users and the core network 18, which can be used to transport data to and from other locations via wired and/or wireless communications links.

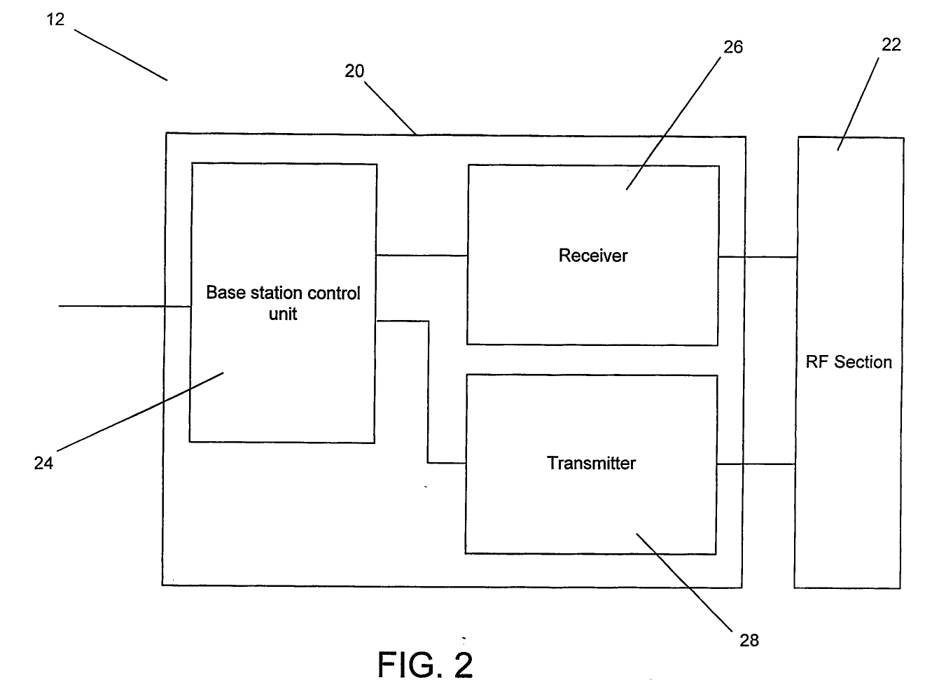

A WCDMA base station in accordance with the present invention is illustrated in FIG. 2. The WCDMA base station 12 includes a signal processing unit 20 and an RF section 22. The signal processing unit includes abase station control unit 24 that acts as an interface between the core network and the transmitter circuitry 26 and between the core network and the receiver circuitry 28. The base station control unit can also be responsible for handover of calls to or from another base station, paging of a user device and the assignment of resources to users. The interface between the base station control unit and the core network can be achieved using interfacing electronics, which in one embodiment can consist of a radio network controller as is specified in European Telecommunications Standards Institute (ETSI) Universal Mobile Telecommunications Systems (UMTS) standard architecture or other network interfacing devices. The transmitter circuitry is used to transmit data provided to it by the base station control unit on the downlink channel. The manner in which the data is transmitted is controlled by instructions that are also provided by the base station control unit. The receiver circuitry is used to receive communications from the users on the uplink channels. In one embodiment, the WCDMA base station is implemented using devices compliant with the UMTS standard architecture that are configured in the manner described below.

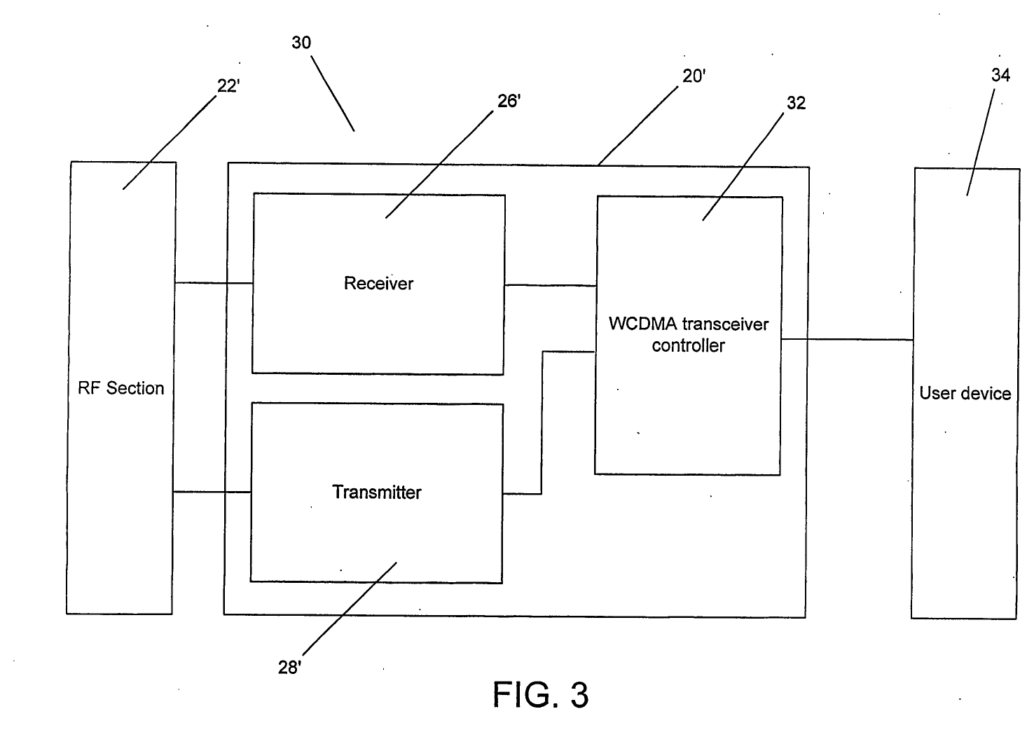

A user WCDMA transceiver in accordance with the present invention is illustrated in FIG. 3. The WCDMA transceiver 30 is similar to the WCDMA base station, except that a WCDMA transceiver controller 32 is substituted for the base station control unit of FIG. 2 and the WCDMA transceiver interfaces with a user device 34 as opposed to the core network. In one embodiment, the WCDMA transceiver can be implemented using devices that are complaint with the ETSI UMTS standard that are configured to operate in the manner described below.

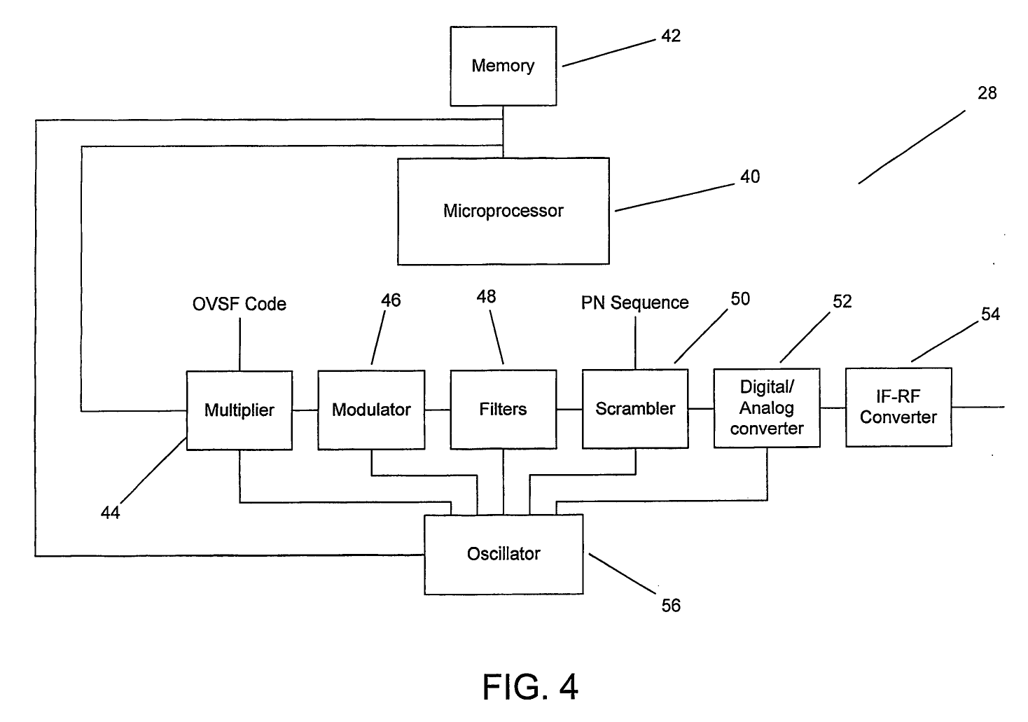

An embodiment of transmitter circuitry 26 in accordance with the present invention is illustrated in FIG. 4. The transmitter circuitry includes a microprocessor 40 connected to memory 42. The microprocessor and memory are also connected to a multiplier 44. The output of the multiplier is provided to a modulator 46, which in turn provides an output to a scrambler 48. The output of the scrambler is filtered by a filter 50 and then provided to a digital to analog converter 52. The modulator 54 modulates the analog output of the digital to analog converter is modulated onto an intermediate frequency carrier, which can then be upconverted to an appropriate higher frequency carrier by the RF section. In one embodiment, the operations of each of the components outlined above are coordinated using a local oscillator.

The microprocessor is responsible for receiving data from the base station control unit for transmission on the downlink channel. Tail insertion and channel coding are performed on the data by the microprocessor to provide error detection and recovery. The microprocessor may also perform puncturing or unequal repetition of the data to modify the transmission rate of the data relative to the symbol rate of the transmission system. Once these functions are performed, the data can be combined with other information such as signaling and control information. The combined data and control information are then provided to the multiplier, which spreads the data and control information using an assigned OVSF code. The spread data is then modulated in accordance with the modulation scheme used by the transmitter. In one embodiment, the data is modulated in accordance with a quadrature phase shift keying (QPSK) transmission scheme. The modulated data is provided to a scrambler where a psuedo-random noise sequence is used to scramble the data and reduce the interference that may arise due to transmission using the same OVSF code and bandwidth by proximate base stations. Once the signal has been filtered, a digital to analog conversion is performed and the resulting baseband signal is modulated onto an intermediate frequency carrier wave that can be provided to the RF section. In other embodiments, the transmitter circuitry can use quadrature phase shift keying, quadrature amplitude modulation (QAM) or other modulation schemes, may not involve scrambling, utilize space time encoding to accommodate multiple transmitter and receiver antennas or can involve any other transmission configuration that requires the spreading of data using one of a set of orthogonal spreading codes. In other embodiments, the transmitter can be implemented using a single application specific integrated circuit, the functions performed by the microprocessor can be performed using application specific integrated circuits, the microprocessor can perform additional functions and the multiplier, modulator, filters, scrambler, digital to analog converter or IF-RF converter can include one or more microprocessors.

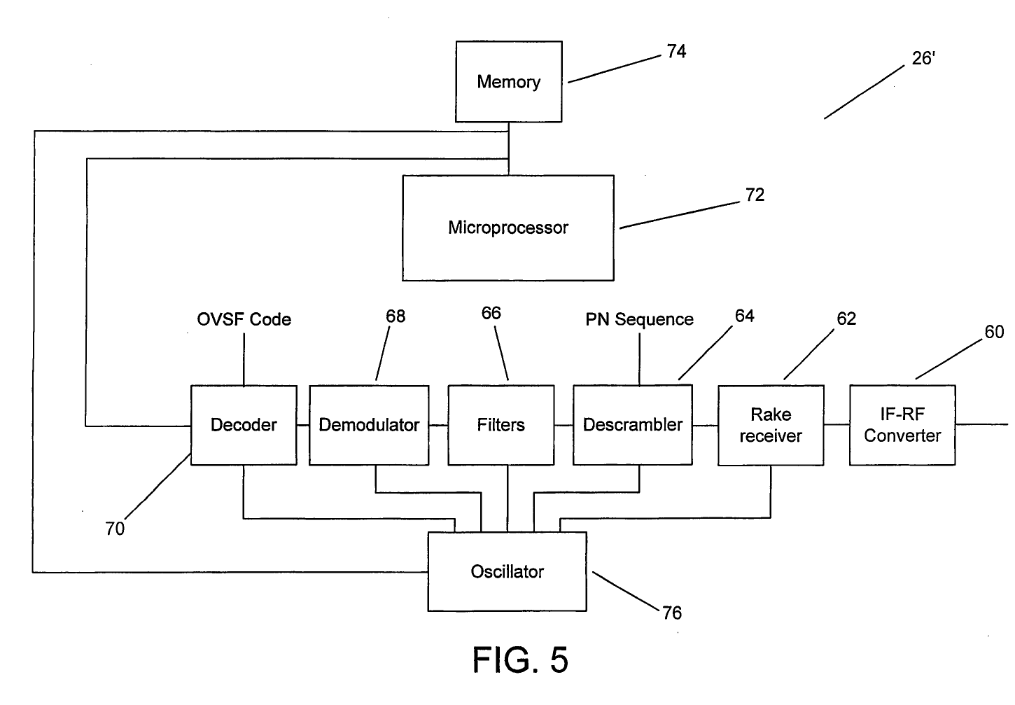

A receiver that forms part of a user WCDMA transceiver in accordance with the present invention is illustrated in FIG. 5. The receiver includes an IF-RF converter 60 connected to a to a RAKE receiver 62, which provides an output to a descrambler 64. The output of the descrambler is filtered by filters 66 and provided to a demodulator 68. The demodulator output is then provided to a decoder 70 and then to a microprocessor 72. The microprocessor is connected to memory 74 for data storage and the actions performed in the receiver are coordinated using an oscillator circuit 76.

The IF-RF converter down converts the RF signal received by the receiver and provides it to a RAKE receiver, which generates a digital signal in a manner that accounts for multipath interference generated in the wireless channel. In other embodiments, other receiver structures can be used. The digital signal is descrambled using the same psuedo-random code that was used to scramble the transmitted signal and then filtered. The filtered signal is demodulated and provided to a decoder, which extracts the data bits from the output of the demodulator using the OVSF code used to spread the data prior to transmission. The microprocessor then performs functions to reverse the effects of puncturing or unequal repetition that was performed by the microprocessor in the transmitter. In other embodiments, discrete components, a single or multiple application specific integrated circuits, additional microprocessors or a combination of these components can be used to implement the receiver.

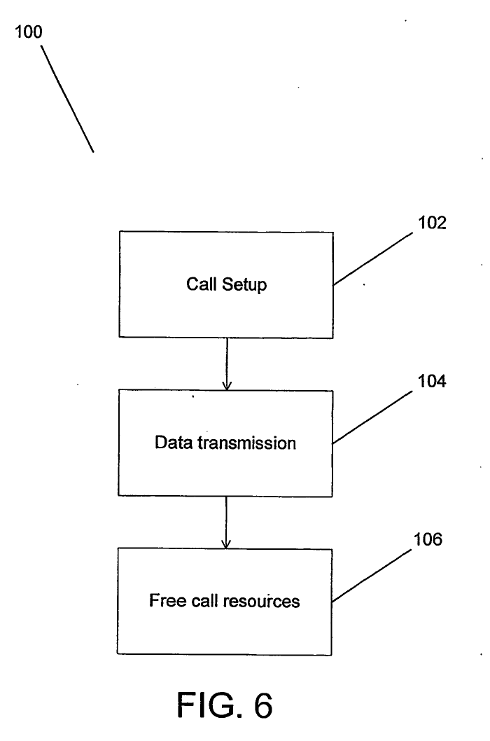

A process in accordance with the present invention for transmitting data between two devices using WCDMA is illustrated in FIG. 6. The process 100 involves an initial call setup (102) and then the transmission (104) of data. The process is completed by freeing (106) the resources required by the call.

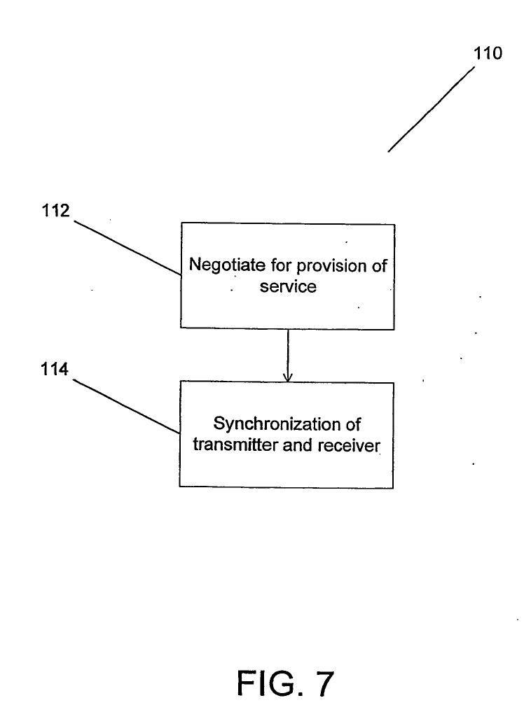

A process in accordance with the present invention for call setup is illustrated in FIG. 7. The process 110 includes negotiating (112) for the provision of a desired service and the synchronization (114) of the transmitter and receiver to enable data transmission to occur.

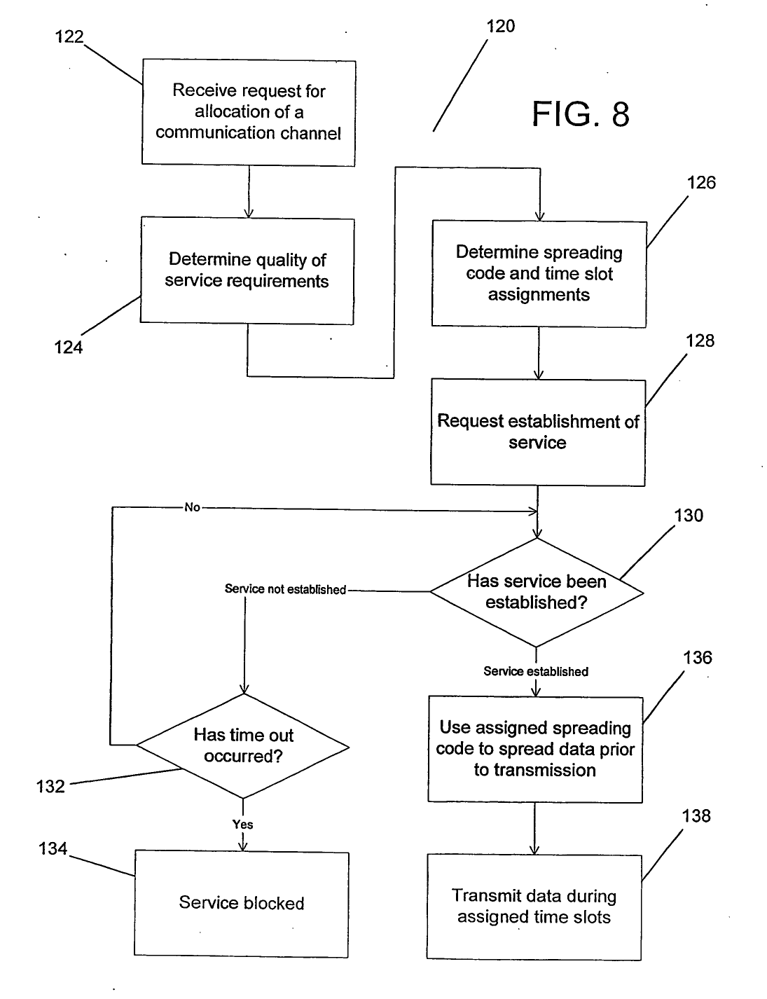

A process in accordance with the present invention for requesting the establishment of a service is shown in FIG. 8. The process 120 includes receiving (122) a request for the allocation of a communication channel. When a request has been received, the quality of service requirements required for the requested service are determined (124). The spreading code and the number of time slots that are to be assigned (126) to the service are then determined based on these quality of service requirements. The spreading code and time slot assignments are then used to request (128) to another device that the desired service be established. Once a request has been sent, the process cannot continue unless a service is established or a predetermined time period elapses. Therefore, a decision (130) is performed to determine if a response establishing a service has been received. If a response has not been received, then the process requires that a decision (132) be made concerning whether a timeout has occurred. If a time out has occurred, then the service is blocked (134) and this information must be conveyed to the service requestor. If a timeout has not occurred, then the process continues to wait for a message indicating that the service can be established. If a service is established, then the data to be sent on the service is spread (136) using the assigned spreading code. The spread data is then transmitted (138) during the assigned time slots.

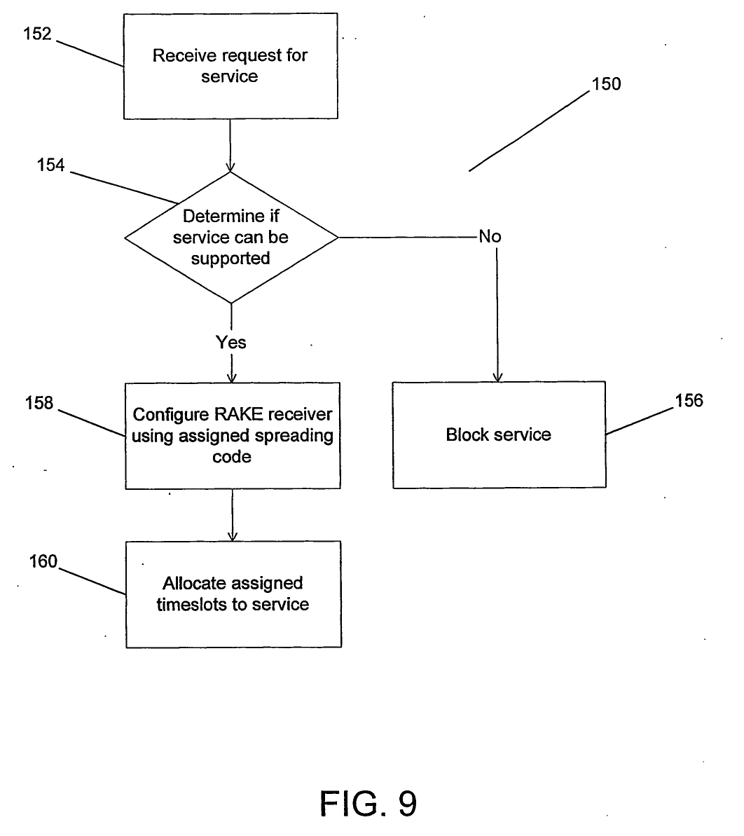

A process in accordance with the present invention for responding to a request by another device to transmit information is shown in FIG. 9. The process 150 involves receiving (152) a request for the establishment of a service. Once the request is received, a decision (154) is performed to ascertain if the service can be supported. If the service cannot be supported, then the call is blocked (156) either by sending a response to this effect or by allowing the request to time out. If sufficient resources are available to establish the service, then receiver hardware is configured (158) using the assigned spreading code and the assigned time slots are allocated (160) to the new service.

Typically, all OVSF codes assigned on the downlink of a system in accordance with the present invention will have the same spreading factor. The time that the transmitter spends transmitting on the downlink is divided into frames of equal length that are made up of a number of time slots. Varying effective data rates for different services can be achieved by making allocations of between one and all of the time slots in every transmission frame to specific services.

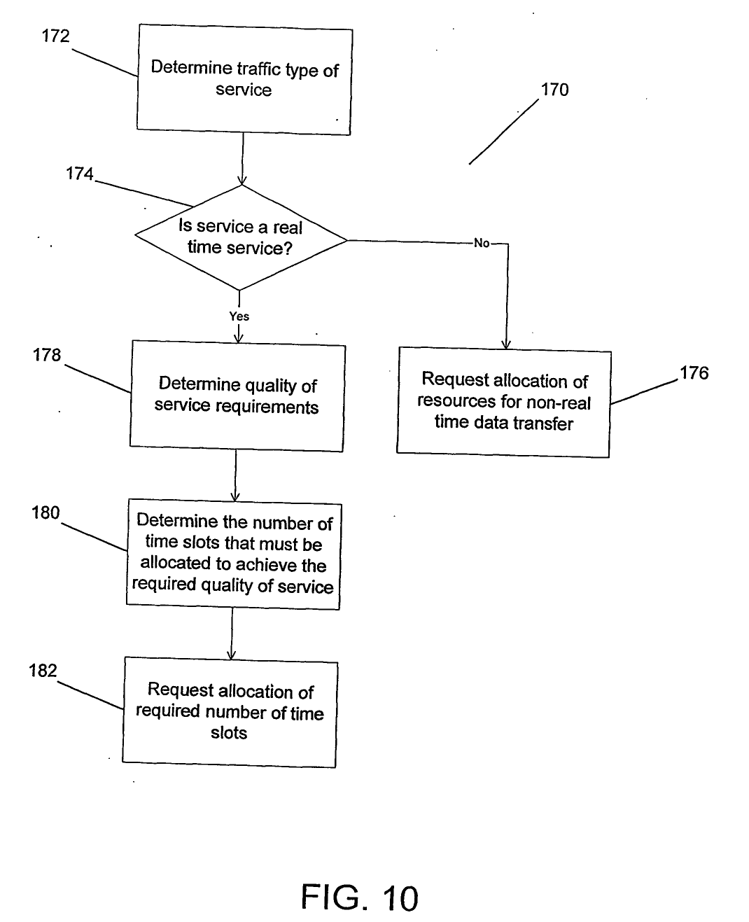

A process in accordance with the present invention for determining the number of time slots in each frame that are required by a particular service is illustrated in FIG. 10. The process 170 includes determining (172) the traffic type of the service. If the traffic is a non-real time service, then the traffic is handled (174) using well known techniques for transmitting non-real time data using a WCDMA system. In the event that the data is real time, then the process requires that the quality of service requirements of the service be determined (176). The number of time slots that must be allocated to achieve the required quality of service is then determined (178) and a request is made (180) for the assignment of the required number of time slots. In one embodiment, the quality of service requirements are converted into a required bit rate and the number of time slots is then determined based on the transmission rate of the transmitter and the spreading factor of the OVSF code assigned to the service. In other embodiments, time slots are allocated based on empirical information obtained as a result of monitoring the historical performance of the network. Alternatively, the number of time slots assigned can adapt if the quality of service requirements are not being met during the call.

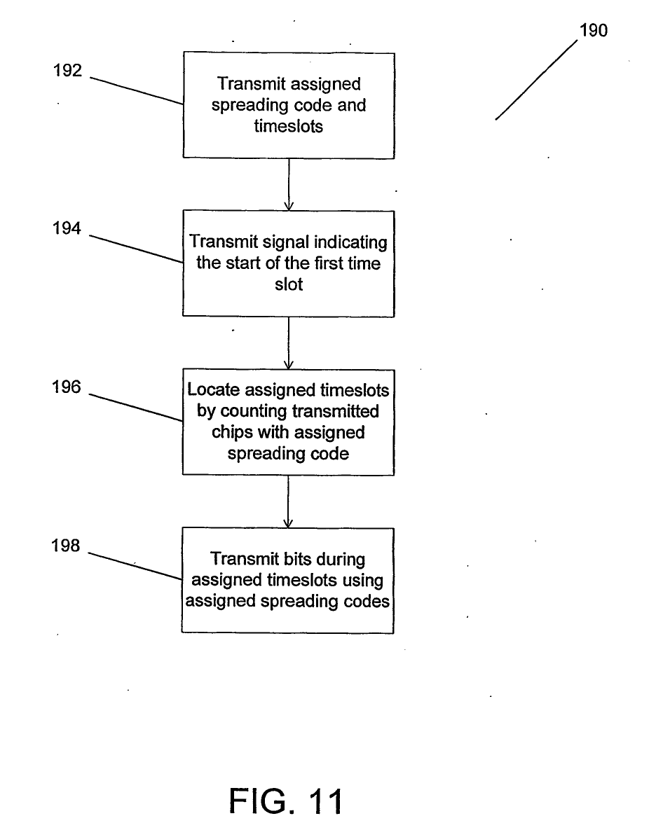

A process for synchronizing the transmission of data in accordance with the practice of the present invention is illustrated in FIG. 11. The process 190 involves transmitting (192) assigned spreading codes and time slots to the intended receiver and then transmitting (194) a time slot to the receiver to indicate that the commencement of the transmission of the first time slot. The assigned time slots can then be located (196) by counting transmitted chips possessing the assigned spreading code. Once the assigned time slots have been located, data can then be transmitted (198) using the assigned spreading code. In other embodiments, global synchronization can be used to locate assigned time slots or other synchronization techniques can be used to enable the transfer of data to a receiver. In one embodiment, the signal used to indicate the start of the transmission of the first time slot can be sent using a separate signaling channel. In other embodiments, the signal can be sent as a characteristic chip pattern at the completion of each cycle of time slots or using any equivalent technique.

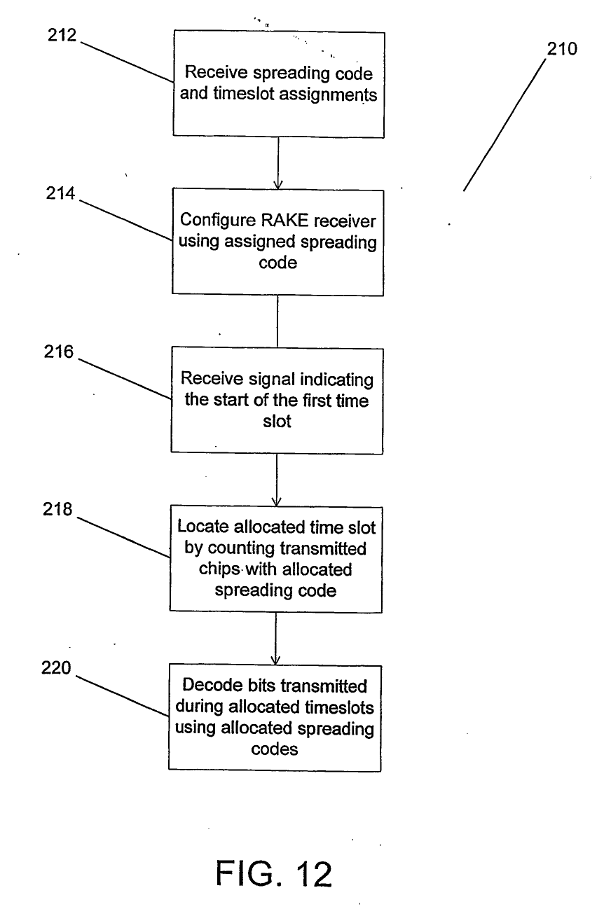

A process in accordance with the present invention for receiving data transmitted on specific time slots using an assigned spreading code is illustrated in FIG. 12. The process 210 includes receiving (212) spreading code and time slot assignments. A RAKE receiver can be configured (214) using the assigned spreading code. Once a signal indicating the commencement of the transmission of the first time slot is received (216), then the assigned time slots can be located (218) by counting transmitted chips with the allocated spreading codes. The chips transmitted during these time slots can then be decoded (220) using the allocated spreading code to extract the transmitted data. In other embodiments, chips may not be counted but may instead be used to synchronize a local oscillator using a phase locked loop. Synchronizing a local oscillator in this way prevents the need for chips to be transmitted continuously in order for a transmitter to locate allocated time slots. In one embodiment, the signal indicating the start of the first time slot is received on a separate signaling channel. Alternatively, the signal may be transmitted as a characteristic chip pattern that is transmitted prior to the transmission of the first time slot or the signal may be communicated in any other equivalent manner.

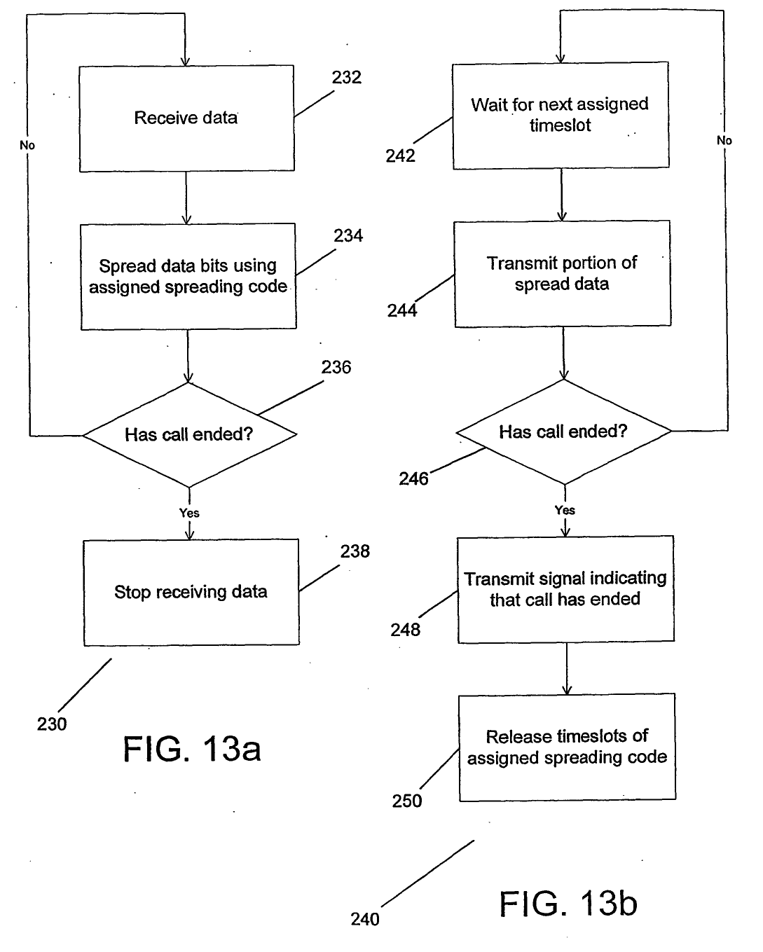

Two processes in accordance with the present invention that can be performed in parallel, when transmitting data are illustrated in FIGS. 13a and 13b. The first process 230 involves receiving data (232) and spreading (234) the received data bits using an assigned spreading code. Once the data has been spread, the process investigates (236) whether the call has ended. If the call has ended, then the process ceases (238) to receive data. If the call has not ended, then the process waits until more data is received. The second process 240 involves waiting (242) for an allocated time slot and once the allocated time slot has arrived, transmitting (244) a portion of the spread data. The process then determines (246) whether the call has ended. If the call has ended, then a signal is transmitted (248) indicating that the call has ended and the time slots of the assigned spreading code are freed (250) so that they can be used by another service. If the call has not ended, then the process waits (242) for the next assigned tine slot in order to transmit (244) more spread data. In one embodiment, the signal indicating that the call has ended can be transmitted using a separate signaling channel. In other embodiments, the signal indicating that the call has ended can be multiplexed with the data, transmitted in a separate time slot to the time slots assigned for the transmission of data or communicated in any other equivalent manner.

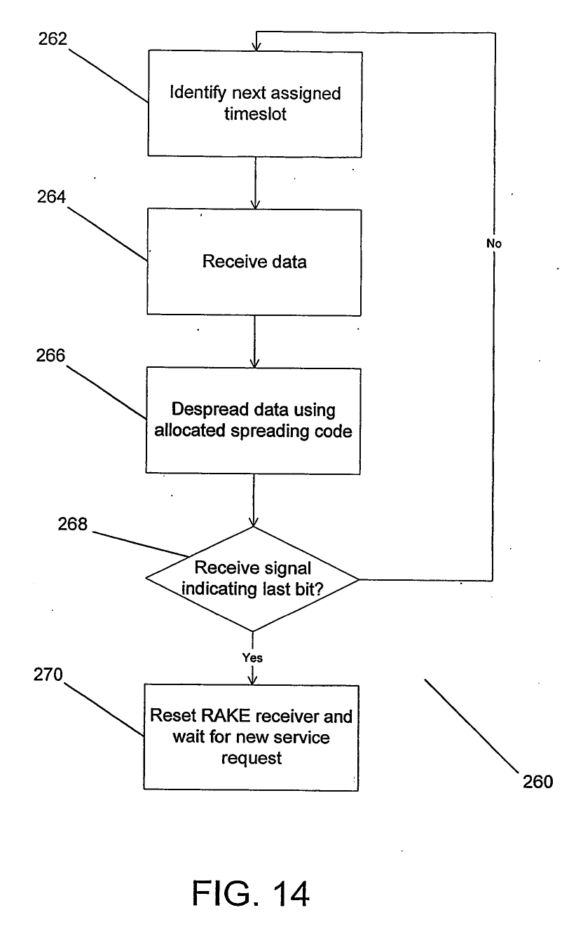

A process for receiving data transmitted in accordance with practice of the present invention is shown in FIG. 14. The process 260 involves identifying (262) the next assigned time slot and then receiving (264) and despreading (266) the data transmitted during that time slot. The process then determines (268) if a signal has been received indicating that the call has ended. If such a signal has been received, then the RAKE receiver is reset (270) in preparation for another service request. If no signal indicating that the call has ended has been received, then the process identifies (262) the next assigned time slot in order to receive more data.

The systems and processes described above involve dividing the downlink channel into periodically repeating time slots that are assigned to services according to their quality of service requirements. This system can prevent blocking between OVSF codes by ensuring that all OVSF codes have the same spreading factor. Other embodiments of the system in accordance with the present invention do not divide the downlink channel into time slots. Instead, these embodiments use non-blocking OVSF codes to satisfy various quality of service requirements. The non-blocking OVSF codes also avoid underutilization of the downlink channel that can be caused by the blocking properties of conventional OVSF codes.

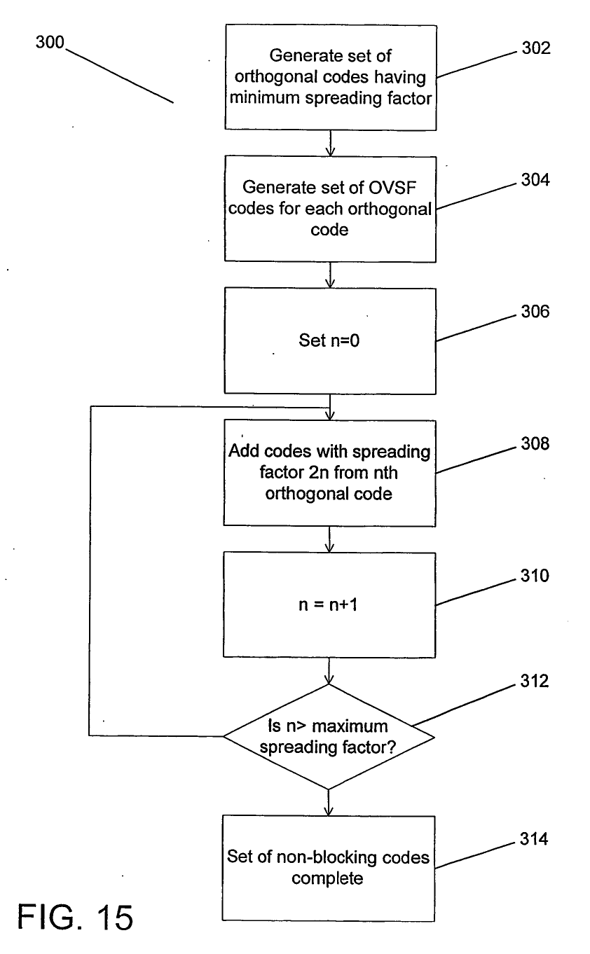

Non-blocking OVSF codes are direct substitutes for OVSF codes in conventional WCDMA systems such as systems that are in compliance with the ETSI UMTS standard. A process for generating non-blocking OVSF codes in circumstances where desired minimum spreading and maximum spreading factors are specified is illustrated in FIG. 15. The process 300 involves generating (302) a number of orthogonal codes greater than or equal to the base 2 logarithm of the maximum desired spreading factor minus the base 2 logarithm of the minimum desired spreading factor using the formula specified above (see background) such that each of the orthogonal codes has the minimum desired spreading factor. The same formula is then used to generate (304) spreading codes having spreading factors between the minimum desired spreading factor and the maximum desired spreading factor using each of the orthogonal codes. The final non-blocking OVSF code set is developed by taking the first orthogonal code as an orthogonal code possessing the minimum spreading factor. Then the codes with a spreading factor that is twice the minimum spreading factor that were generated using the second orthogonal code are added to the set and the codes with a spreading factor that is four times the minimum spreading factor that were generated using the third orthogonal code are also added to the set until each orthogonal code has contributed a group of generated codes possessing the same spreading factor to the final set of non-blocking OVSF codes. Each group generated from an orthogonal code that is contributed to the final set of non-blocking OVSF code is subject to the condition that it must possess a different spreading factor to the groups of codes previously contributed to the final set of non-blocking OVSF codes. This part of the process can be implemented by setting (306) an arbitrary variable n to 0 and then adding (308) all of the codes generated from the nth orthogonal code with a spreading factor of 2ⁿ to the final set of non-blocking OVSF codes. The variable n is then set (310) to the value n+1 and compared (312) to the maxim desired spreading factor. If the value of n is not greater than the maximum desired spreading factor, then the codes from the nth orthogonal code with a spreading factor of 2′ are added to the final set of non-blocking OVSF codes. If the value of n is greater than the maximum desired spreading factor, then the final set of non-blocking OVSF codes has been completely generated (314).

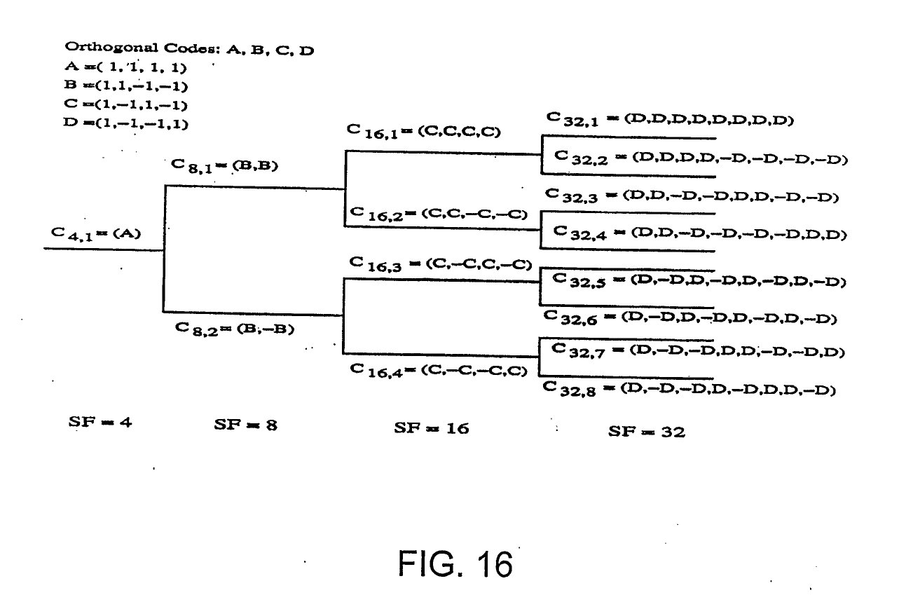

An example of this process is illustrated in FIG. 16 using a binary tree. The illustrated binary tree 320 shows the final set of non-blocking OVSF codes for a system possessing a minimum spreading factor of 4 and a maxim spreading factor of 32. Each generation of the tree is constructed from codes that are generated using a different code from the initial group of orthogonal codes that are specified as codes A, B, C and D. Code trees similar to the code tree illustrated in FIG. 16 can be used as an alternative method of generating non-blocking OVSF codes for systems possessing predetermined minimum and maximum allowable spreading factors.

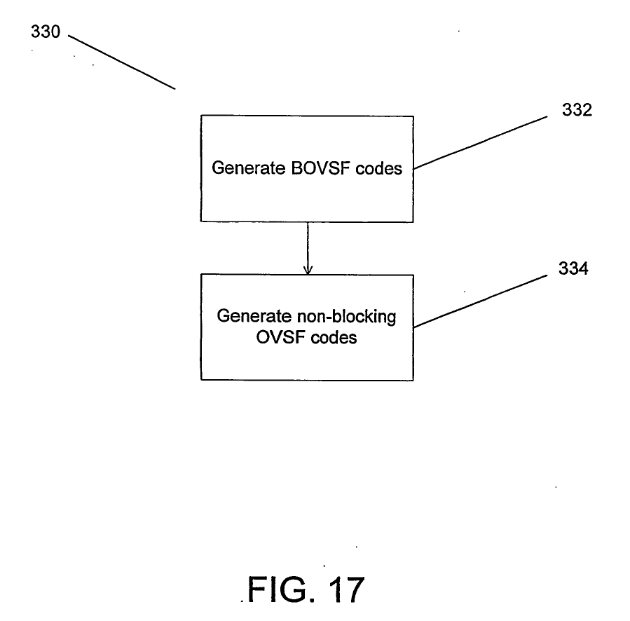

A process in accordance with the present invention for generating non-blocking OVSF codes in circumstances where there is no upper bound on the spreading factor allowed by a system is illustrated in FIG. 17. The process 330 involves generating base OVSF (BOVSF) codes 332 and then generating non-blocking OVSF 334 codes using the BOVSF codes.

BOVSF codes are generated according to the following rules:
Let A=[1]
Each BOVSF code X can be used to generate two orthogonal codes:
[X, X, X, x] and [X, −X]
where −X is the inverted sequence of X

The BOVSF codes generated recursively using the above rules share the properties of OVSF codes in that all codes on the same layer of the BOVSF code-tree are orthogonal to each other and that any two codes of different layers are orthogonal except for the case that one of the two codes is a parent code of the other.

Non-blocking OVSF codes are generated from BOVSF codes using the following rule:
Each BOVSF code Y of spreading factor k can be used to generate a non-blocking OVSF code with a spreading factor of 4k:
[Y, Y, −Y, −Y]
where −Y is the compliment of Y.

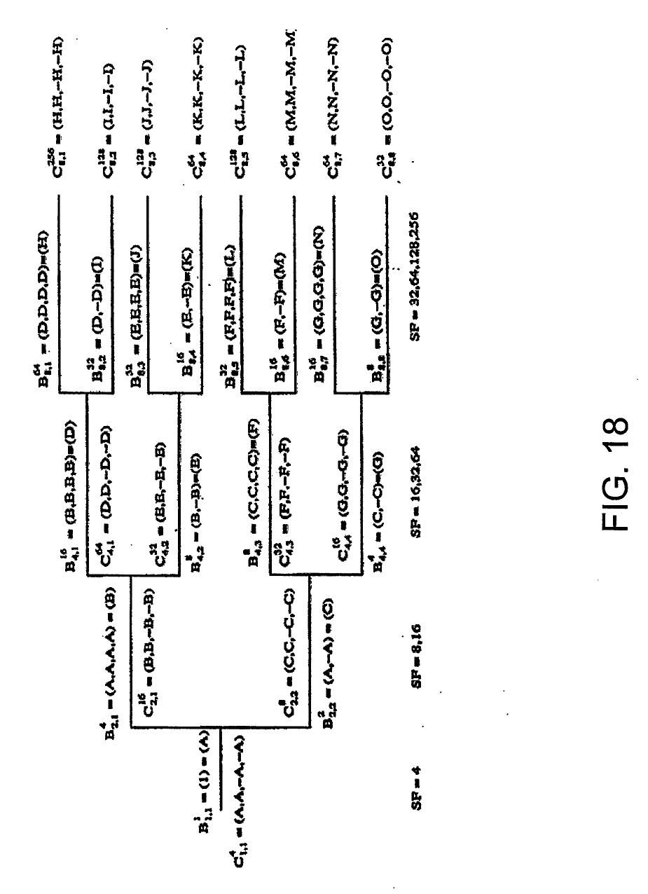

A binary tree illustrating the BOVSF codes and the non-blocking OVSF codes generated from the BOVSF codes is illustrated in FIG. 18. The BOVSF codes are indicated on the binary tree 340 using the notation B^{s}_{n,i} and the non-blocking OVSF codes are indicated using the notation C^{s}_{n,i}, where s is the spreading factor, n is the number of codes in a layer of the code tree and i is the index of the code.

While the above description contains many specific embodiments of the invention, these should not be construed as limitations on the scope of the invention, but rather as an example of one embodiment thereof. The various techniques described above for avoiding blocking between spreading factor codes can be used in combination and with a variety of minimum and maxim spreading factors. Accordingly, the scope of the invention should be determined not by the embodiments illustrated, but by the appended claims and their equivalents.

1. A WCDMA transmission system for transmitting real time data that has specified quality of service requirements, comprising:
a WCDMA transmitter configured to spread the data using an OVSF code and to periodically transmit the spread data for a predetermined time until all of the data has been transmitted; and
wherein the amount of time in each period that is assigned for transmission of the spread data is determined based on the quality of service requirements of the data.

2. The WCDMA transmission system of claim 1, further comprising:
a WCDMA receiver configured to receive data periodically transmitted for a predetermined time using a predetermined OVSF code.

3. The WCDMA transmission system of claim 2, wherein:
the WCDMA transmitter is also configured to transmit messages indicative of the time allocated during each period for transmission of the data and messages indicative of the OVSF code used to transmit the data; and
the WCDMA receiver is also configured to receive the messages transmitted by the WCDMA transmitter.

4. The WCDMA transmission system of claim 2, wherein the WCDMA receiver is configured to synchronize to the transmissions of the WCDMA transmitter.

5. The WCDMA transmission system of claim 2, wherein:
the WCDMA transmitter is connected to a core network; and
the WCDMA receiver is connected to a user device.

6. A method of communicating real time data from a service, comprising:
determining the quality of service requirements of the service;
determining the number of time slots that must be assigned to the service for the quality of service requirements to be met if the data is transmitted using a predetermined spreading factor;
assigning time slots to the service;
assigning an OVSF code possessing the predetermined spreading factor to the service;
spreading the data using the assigned OVSF code; and
periodically transmitting the spread data during the assigned time slots.

7. The method of claim 6, further comprising:
transmitting messages indicating assigned time slots and an assigned OVSF code; and
transmitting signals that can be used to identify the time at which the spread data is transmitted.

8. The method of claim 6 wherein the OVSF code is selected from an OVSF code set formed by:
generating a first plurality of orthogonal codes having spreading factors in a range from a minimum spreading factor to a maximum spreading factor;
selecting an orthogonal code with the minimum spreading factor from the first plurality of othogonal codes;
selecting a second plurality of orthogonal codes with spreading factors twice the minimum spreading factor from the first plurality of orthogonal codes; and
selecting a third plurality of orthogonal codes with spreading factors four times the minimum spreading factor from the first plurality of orthogonal codes.

9. The method of claim 8 wherein the OVSF codes set is further formed by continuing to select further plurality of orthogonal codes from the first plurality of othogonal codes, with each successive plurality of orthogonal codes having spreading factors twice the spreading factors of the subsequent plurality of othogonal codes, until the maximum spreading factor has been reached.

10. The method of claim 6 wherein the OVSF code is non-blocking OVSF code selected from an OVSF code set formed by recursively generating BOVSF codes and generating non-blocking OVSF codes from the BOVSF codes.

11. The method of claim 10 wherein generating non-blocking OVSF codes from the BOVSF codes comprises selecting a BOSVF code Y with a spreading factor k and generating a non-blocking OVSF code with a spreading factor of 4k and of the form [Y,Y,−Y,−Y], where −Y is the compliment of Y.

12. The WCDMA transmission system of claim 1 wherein the OVSF code is selected from an OVSF code set formed by:
generating a first plurality of orthogonal codes having spreading factors in a range from a minimum spreading factor to a maximum spreading factor;
selecting an orthogonal code with the minimum spreading factor from the first plurality of othogonal codes;
selecting a second plurality of orthogonal codes with spreading factors twice the minimum spreading factor from the first plurality of orthogonal codes; and
selecting a third plurality of orthogonal codes with spreading factors four times the minimum spreading factor from the first plurality of orthogonal codes.

13. The WCDMA transmission system of claim 12 wherein the OVSF codes set is further formed by continuing to select further plurality of orthogonal codes from the first plurality of othogonal codes, with each successive plurality of orthogonal codes having spreading factors twice the spreading factors of the subsequent plurality of othogonal codes, until the maximum spreading factor has been reached.

14. The WCDMA transmission system of claim 1 wherein the OVSF code is non-blocking OVSF code selected from an OVSF code set formed by recursively generating BOVSF codes and generating non-blocking OVSF codes from the BOVSF codes.

15. The WCDMA transmission system of claim 14 wherein generating non-blocking OVSF codes from the BOVSF codes comprises selecting a BOSVF code Y with a spreading factor k and generating a non-blocking OVSF code with a spreading factor of 4k and of the form [Y,Y,−Y,−Y], where −Y is the compliment of Y.
